(19) United States
(12) Patent Application Publication
(10) Pub. No.: US 2003/0092438 A1
(43) Pub. Date: May 15, 2003

(54) Method and apparatus for stabilizing calls during a system upgrade or downgrade

(76) Inventors: Brian J. Moore, Palatine, IL (US); Thomas E. Shirley, Bartlett, IL (US); Kevin Kruse, Warrenville, IL (US); Thomas J. Weiss, Chicago, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 09/993,991

(22) Filed: Nov. 14, 2001

(51) Int. Cl. H04Q 7/20

(52) U.S. Cl. 455/423; 455/419

(57) ABSTRACT

A method of ensuring stability of wireless communications that are in danger of suffering a service disconnect due to a processor software upgrade or downgrade. The method includes the use of a control block which contains the version number of the application operating on both the primary and secondary processors. The primary controller writes state data to its control block and a checkpointing service replicates the data to the control block of the updated secondary processor. The control block coordinates appropriate version format conversions and allows the secondary processor to read the saved state data and assume control of the wireless communications with little or no loss of service.

### FIELD OF THE INVENTION

The present invention relates generally to voice and data call stabilization in a mobile communication system, and more particularly to a method and apparatus for stabilizing voice and data calls within a mobile telephony system which allows for an enhanced application upgrade or downgrade feature.

### BACKGROUND ART

In a typical high-availability cellular environment, software updates are inevitable and may cause a massive disruption of service during such processes, including the disconnect of stable calls. In a typical cellular environment an active processor will normally have a standby processor in the event of fault or failure. During operations, the processor that is processing call traffic is called the primary processor while the standby processor is called the secondary processor. If a fault or failure occurs in the primary processor, or in the event of a system upgrade or downgrade, the secondary processor must take over the operations of the primary with a minimal loss of services, including call processing.

For example, in a cellular environment, if the primary and secondary processors are responsible for controlling a base transceiver station (BTS), the processor may be responsible for the coordination and control of hundreds of wireless connections. If the primary processor is unable to continue its operations, either due to a planned graceful shutdown, or an abnormal condition, the secondary processor must be able to take control quickly and with the proper data to save the wireless connections.

One way in which the smooth transfer of control from the primary processor to the secondary processor may be effected is by the use of a checkpointing service. In such a system, the primary processor stores state data which represents the current steady state of operation. The state data must then be replicated to the secondary processor to allow the secondary processor to take over call processing from the primary processor without dropping stable calls in the event of a primary failure. Checkpointing is a service that copies the primary state data to a secondary processor as often as the saved state data changes. The primary processor will usually checkpoint a given block of data between the two processors when a steady state has occurred. When a failure occurs, the secondary processor simply reads the state data provided by the primary processor and takes over the processing with little or no interruption of service, depending upon the speed of the take over and the freshness of the data.

State data, however, must also be reflected to the secondary processor during software upgrades or downgrades wherein the process is complicated since the state data or state data formatting might have changed during the software upgrade or downgrade. Therefore, a system which ensures stable call processing during system updates must be capable of converting state data to be compatible with the new service release.

One alternative to converting state data is to simply disconnect all services while performing the upgrade or downgrade to the system, without worrying about maintaining current state data, or wireless service. While this brute force approach has been widely employed in the past, it has limited practical appeal. Today's sophisticated wireless consumer has grown to expect and come to rely upon continuous, uninterrupted service from their wireless provider even during release changes. This in turn has made cellular providers weary of changes to their services for fear of disruption of service.

Another alternate method is to employ a common state data format that is capable of being understood by all software versions. Therefore, when a processor makes a transition from a secondary role to a primary role, it must convert the saved state data to one which is current with that processor's software release and then write the converted state data back to the checkpoint service. The data conversion may entail both the addition and/or removal of information to or from the common format. The processor producing the converted state data need not know the version of the software that will consume the state data. The processor producing the data only needs to know one format for the data it needs to checkpoint. This method, however, has proven to be very difficult to manage since every application version needs to know how to convert every other version whether it is newer or older. Furthermore, the computer time necessary to convert the state data to a common format makes this method extremely inefficient.

Thus there is a need for a stabilization technology which protects wireless communications that are in danger of being dropped during an upgrade or downgrade of services by reducing the complications associated with checkpointing state data.

### BRIEF DESCRIPTION OF THE DRAWINGS

The features and advantages of the present invention will become more apparent from the following detailed description of the preferred embodiments of the invention taken in conjunction with the drawings.

FIG. 1 is a diagram of a typical wireless communication system suitable for use in accordance with the teachings of the present invention.

FIG. 2 is a block diagram of a stabilization system which may be used to implement the present invention.

FIGS. 3 and 4, when joined along similarly-lettered lines, together comprise a generalized flowchart of programming executed by the stabilization system of FIG. 2.

### DESCRIPTION OF THE PREFERRED EMBODIMENT

The present invention provides a method and apparatus that addresses the above-mentioned problems by stabilizing wireless communications that are in danger of suffering a service disconnect due to a processor software upgrade or downgrade. The method generally involves the use of a control block which contains the version number of the application operating on both a primary and secondary controller. The primary controller writes state data to its control block, a checkpointing service replicates the data to the control block of the secondary controller, wherein the secondary processor is capable of reading the saved state data to assume processing control if necessary. If the secondary controller assumes system control and is operating on a different application version, the control block may coordinate appropriate version format conversions. The method may be implemented on any computer system, or for example, on any computer system located at an appropriate location within a wireless communication system, for instance, at a base transceiver station. It will be noted, however, that while the description of the preferred embodiment detailed below references a wireless cellular system, it will recognized by those skilled in the art that the present invention may be applied to any computer system requiring processor backup during application upgrades or downgrades without loss of critical functionality.

Furthermore, while the below embodiment is in reference to a wireless communication system with two controllers, a primary and secondary, it will be recognized by those skilled in the art that the system may be utilized on any system with multiple controllers. Moreover, while the illustrated example is directed towards a Code Division Multiple Access (CDMA) radio access network, the system may be utilized in any mobile switching environment, including for example, a Global System for Mobile Communication (GSM), a General Packet Radio Service (GPRS) system, or a Universal Mobile Telecommunications System (UMTS).

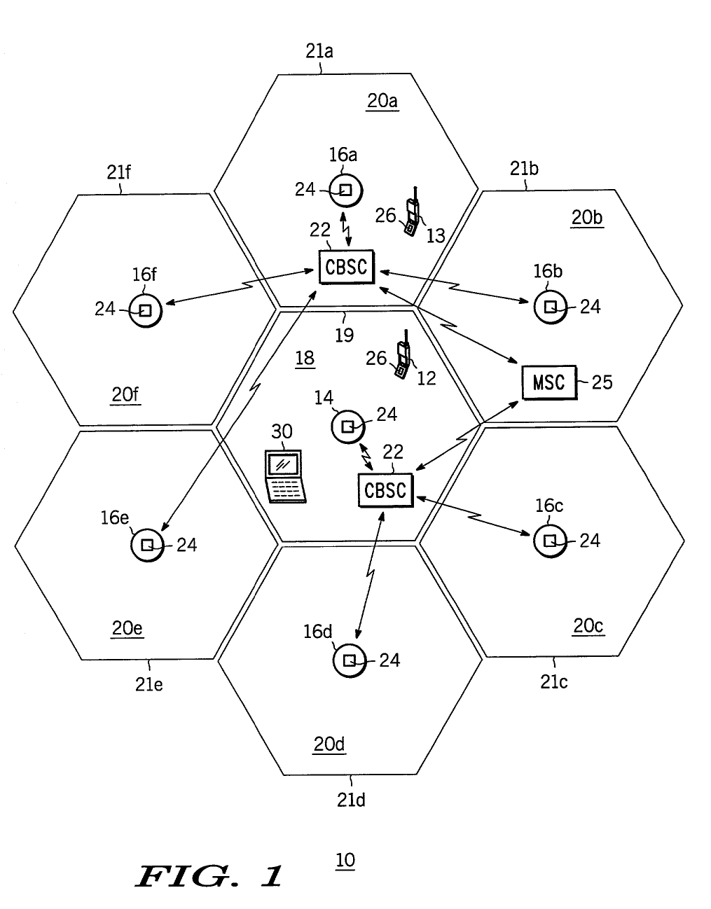

Referring now to the drawings, FIG. 1 illustrates a block diagram of a typical wireless communication system constructed according to the teachings of the present invention and for which the method of the invention is particularly well suited. The communication system 10 has mobile users or units 12 and 13, a first base transceiver station (BTS) 14, and a plurality of surrounding or neighboring base transceiver stations (NBTS) 16a-16f. As generally depicted in FIG. 1, the mobile unit 12 resides at a given time in one cell or sector 18 of the system 10 defined by a boundary range or area 19 that is served by the BTS 14. Each of the NBTS 16a-16f separate respective cell 20a-20f adjacent the cell 18 that are defined by respective boundaries 21a-21f. A centralized base station controller (CBSC) 22 is in communication with the BTS 14 and several of the neighboring NBTS (NBTS 16c-16d). A centralized base station controller (CBSC) 23 is in communication with the other neighboring NBTS (NBTS 16a-16b, and 16e-16f). A mobile switching center (MSC) 25 is in communication with the CBSC 22 and 23.

The system 10 will typically have a large number of mobile users or units 12 and 13 and a plurality of BTSs spread over an area served by the overall system as is known in the art. For convenience of illustration, FIG. 1 only shows two mobile units 12 and 13 and a relatively small number of BTSs including the BTS 14 and the several NBTS 16. Also as is known in the art, the mobile user or units 12 and 13 represent a cellular telephone that can travel with a system user throughout the various cells of the system. The mobile units 12 and 13 can also represent other types of data devices such as a wireless data terminal or phone, video phone, or the like. These types of units transmit data and/or voice signals over the several BTSs of the communication system.

The type of communication system 10 as represented in FIG. 1 can vary within the scope of the present invention, but in one example is a Code Division Multiple Access (CDMA) or CDMA 2000 system as is known in the art. Other examples include a GPRS Support Node (GSN) in the GPRS system, a Base Station Controller (BSC) in the GSM system and a Radio Network Controller (RNC) and Node B in the UMTS system. The system 10 may be any communication system that transmits signaling messages and requires accurate delivery and receipt by mobile stations or units 12 and 13. The BTS 14 and the several NBTS 16 each include a transceiver 24 that has a transmitter and a receiver. The transceiver 24 transmits over-the-air (OTA) radio frequency (RF) signals to be received by the mobile units 12 and 13. This type of transmission is well known in the art and will not be described in any greater detail herein. Transceivers 24 receive messages from the mobile unit 12, also by means well known in the art. Each mobile unit 12 and 13, has a transceiver 26 including a transmitter and receiver. The mobile units 12 and 13 communicate with a BTS by transmitting messages via the transceiver 26 on reverse links, and receives messages via the transceiver 26 that are generated by the BTS on forward links.

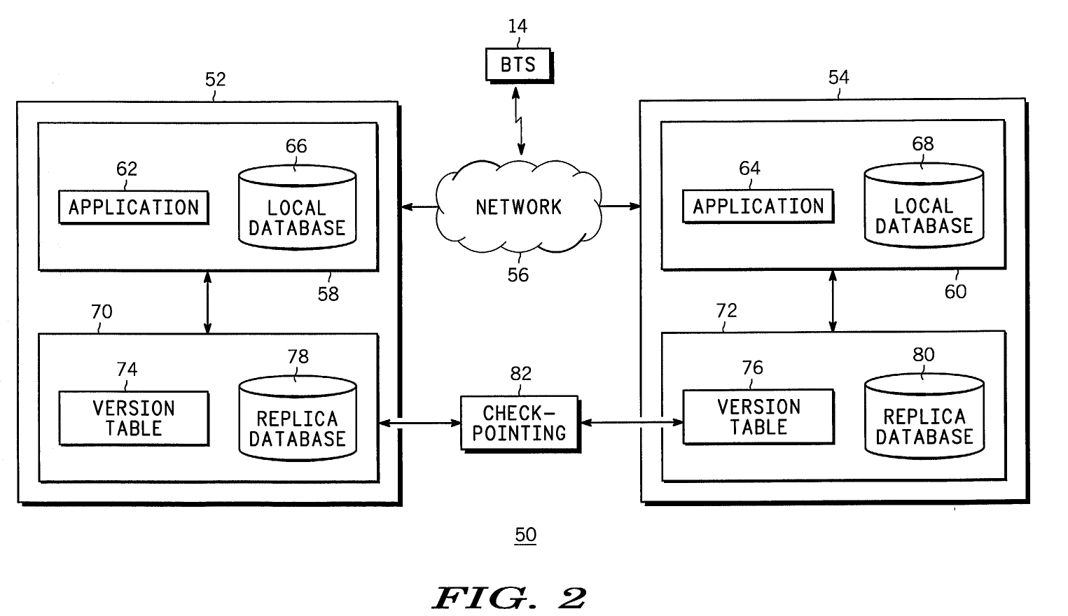

The method of the present invention may be implemented, for example, at the BTS 14 described above, by a stabilization system generally designated by reference 50 as shown in FIG. 2. The system 50 may include a primary controller 52, a secondary controller 54 and a network connection 56 which may form a portion of the embodiment of BTS 14. Each of the primary and secondary controllers may include a processor 58, 60, an application software or hardware 62, 64, a local database 66, 68 of stable and transient data, a control block 70, 72 electronically connected to the processors 58, 60, a control block version table 74, 76, and a replica state database 78, 80 respectively. The control blocks 70, 72 are coupled via a checkpointing service 82 which may be for example, a commercially available checkpointing service such as Eduardo Pinheiro Checkpoint Project (EPCKPT), which operates on the Linux operating system and is copyrighted by Eduardo Pinheiro and distributed under the GNU Copyright License version 2 or later. Alternatively, as will be appreciated by those having ordinary skill in the art, other types of checkpointing services may be used. Generally, the system 50 executes programming stored in a computer-readable memory, a hard drive or other storage device [not pictured], to implement the present invention as described hereinafter. Although the system 50 is depicted with a separate primary controller 52, and a separate secondary controller 54, it will be understood by those skilled in the art that the controllers need not necessarily be two separate elements, rather they may in fact, be one element or multiple elements, so long as the controllers are capable of functioning independently.

During normal operations, the primary processor 58 and the secondary processor 60 are configured to operate the same version of the application software 62 and 64 respectively. During such operations the primary processor 58 writes stable and transient data to its local database 66. When the primary processor 58 reaches a steady state (i.e., stable wireless communications) the stable data is written to the replica state database 78 within the control block 70. The checkpoint service 82 is notified that the state data is available for transfer to the secondary controller 54. The checkpoint service 82 replicates the state data and stores it in the replica state database 80. While the replica databases 78 and 80 are illustrated as separate physical databases, it will be understood that the replica state databases may in fact be merely logical pointers to a single physical database or multiple databases. The control block version tables 74 and 76 indicate that both the primary processor 58 and secondary processor 60 are operating the same version of the application software 62 and 64.

In the event of a fault or failure in the primary controller 52, the system 50 attempts to gracefully shutdown the controller to ensure the controller has the opportunity to update the replica state database 78 and, via the checkpoint service 82, the replica state database 80. Upon shutdown of the primary controller 52, the secondary controller 54 assumes processing control of the system 50. The secondary controller 54 reads the replica state database 80, rebuilds its local database 68, and is therefore able to take control with little or no interruption of wireless service.

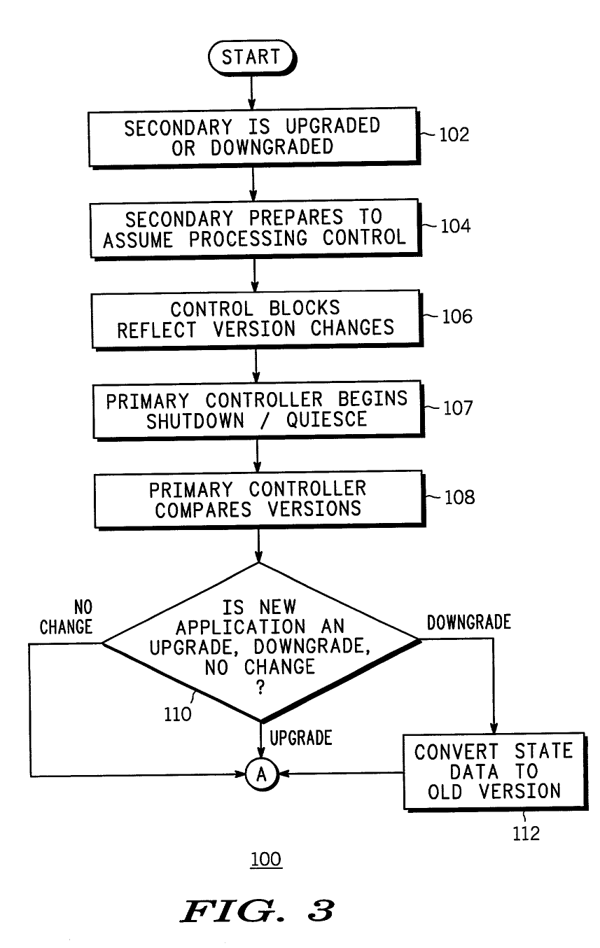

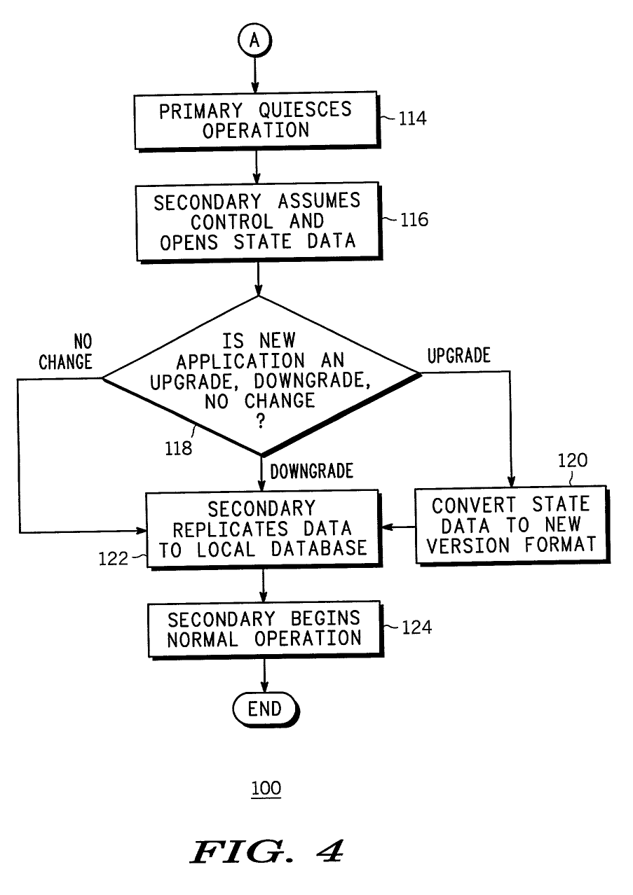

While the above description details one method of stabilizing the system 50 during normal operations, FIGS. 3 and 4 when joined along similarly-lettered lines, together illustrate a flow diagram 100 of one example for ensuring wireless call stability during the upgrade or downgrade of services. Although the flow diagram 100 is directed to wireless call stabilization, it will be recognized that the method of the present invention may be easily adapted to any number of applications which require backup processing during service updates.

An upgrade or downgrade of service generally entails the installation of new application software or hardware on the secondary controller 54. At a step 102, the secondary controller 54 has its application software or hardware 64 upgraded (i.e., the application is updated to a newer release), or downgraded, (i.e., the application has an older version installed). At a step 104, the secondary controller 54 prepares to assume control of the system 50, specifically, the secondary application 64 notifies the secondary control block version table 76 of the new application version number (i.e., the version number of the application that was just installed). Then, at a step 106, the checkpoint service 82 communicates with the primary control block 70 and updates the control block version table 74 to indicate the new secondary application version. At a step 107, the primary controller 52 begins to shutdown or quiesce.

With the secondary controller 54 ready to assume control of the system 50, at a step 108 the primary processor 58 reads the primary control block version table 74 and compares versions of the primary application 62 and secondary application 64. With the results of the version comparison, a step 110 determines whether the change in the secondary application was an upgrade, a downgrade or no change. If the step 110 determines that the new version is a downgrade, a step 112 converts the saved state data to a format compatible to the older application version running on the secondary processor 60, rewrites the converted data to the replica state database 78, notifies the checkpointing service 82 and updates the replica state database 80. The process then continues to a step 114 as shown in FIG. 4. If the step 110 determines that the new version is an upgrade or no change, conversion of the state data may be delayed, and the process continues with the step 114 wherein the primary controller 52 performs a graceful shutdown of services and passes control of the system 50 to the secondary controller 54.

At a step 116, the secondary controller 54 takes over primary control of the system 50 and opens the checkpoint replica database 80 for read and write access, while the primary controller is prepared for its own software upgrade or downgrade. Next, at a step 118, the system 50 determines if the replica state data needs to be converted (i.e., the new application is an upgrade). If the replica state data needs to be converted, indicating that the system has been upgraded, a step 120 converts the data to the new version format and continues processing at a step 122. After conversion, or if the step 118 determined that no conversion was necessary, the secondary processor 60, which now controls the system 50, imports the state data from the replica state database 80 to the local database 68 at the step 122. At step 124, normal operations may resume, as described herein above.

With transfer of control from the primary controller 52 to the secondary controller 54 complete, the system 50 is ready to upgrade or downgrade the primary application 62. It will be noted that once the changes to the primary are complete, the system 50 need not transfer processing control back to the primary until such time as the secondary controller 54 has a fault or failure.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

1. A checkpointing method of stabilizing a wireless communication systems during an upgrade of services, the wireless communication system having a primary controller comprising a first version of a control application, a secondary controller comprising a second version of a control application, and a checkpointing service, the method comprising the steps of:
operating the first version of a control application to control the wireless communication system;
saving state data in a first format, wherein the state data is representative of a stable operation of the wireless communication system, and wherein the first format of the state data is compatible with the first version of a control application;
utilizing the checkpointing service to save the state data to the secondary processor;
upgrading the second version of a control application;
quiescing the primary controller;
operating the upgraded second version of a control application to control the wireless communication system;
converting the saved state data from the first format to a second format, wherein the second state data format is compatible with the upgraded second version of a control application; and
operating the second version of a control application to control the wireless communication system, wherein the second version utilizes the converted state data to ensure wireless communication stability.

2. A method as defined in claim 1, wherein the wireless communication system further has a version control table containing the version number or the first version of a control application and the second version of a control application.

3. A method as defined in claim 2, wherein the step of upgrading the second version of a control application further comprises the steps of:
updating the version control table with the new version of the second version of a control application; and
comparing the version number or the first version of a control application to the second version of a control application to determine the second version of a control application has been upgraded.

4. A method as defined in claim 1, wherein the wireless communication system comprises a network element.

5. A method as defined in claim 4, wherein the network element is an element selected from the group consisting of a Base Transceiver Station (BTS), a Mobile Switching Center (MSC), a Base Station Controller (BSC), a Centralized Base Station Controller (CBSC), a Radio Network Controller (RNC), a Gateway Switching Node (GSN), a Node B, and a mobile unit.

6. A checkpointing method of stabilizing a wireless communication systems during a downgrade of services, the wireless communication system having a primary controller comprising a first version of a control application, a secondary controller comprising a second version of a control application, and a checkpointing service, the method comprising the steps of:
operating the first version of a control application to control the wireless communication system;
saving state data in a first format, wherein the state data is representative of a stable operation of the wireless communication system, and wherein the first format of the state data is compatible with the first version of a control application;
utilizing the checkpointing service to save the state data to the secondary processor;
downgrading the second version of a control application;
converting the saved state data from the first format to a second format, wherein the second state data format is compatible with the downgraded second version of a control application;
quiescing the primary controller;
operating the downgraded second version of a control application to control the wireless communication system; and
operating the second version of a control application to control the wireless communication system, wherein the second version utilizes the converted state data to ensure wireless communication stability.

7. A method as defined in claim 6, wherein the wireless communication system further has a version control table containing the version number or the first version of a control application and the second version of a control application.

8. A method as defined in claim 7, wherein the step of downgrading the second version of a control application further comprises the steps of:
updating the version control table with the new version of the second version of a control application; and
comparing the version number or the first version of a control application to the second version of a control application to determine the second version of a control application has been downgraded.

9. A method as defined in claim 6, wherein the wireless communication system comprises a network element.

10. A method as defined in claim 9, wherein the network element is an element selected from the group consisting of a Base Transceiver Station (BTS), a Mobile Switching Center (MSC), a Base Station Controller (BSC), a Centralized Base Station Controller (CBSC), a Radio Network Controller (RNC), a Gateway Switching Node (GSN), a Node B, and a mobile unit.

11. An apparatus for ensuring wireless communication stability during an update of a wireless communication system, the apparatus comprising:
a first computer processor running a first version of control software, the first computer processor further having a first database capable of saving state data in a first version format representative of steady state operation;
a second computer processor running a second version of control software, the second computer processor further having a second database capable of receiving the state data from the first database in a second version format to replicate the steady state operation of the first computer processor;
a checkpointing service to transfer the steady state data from the first database to the second database; and
a control block to translate the steady state data from the first version format to the second version format.

12. An apparatus as defined in claim 11, wherein the wireless communication system comprises a network element.

13. An apparatus as defined in claim 12, wherein the network element is an element selected from the group consisting of a Base Transceiver Station (BTS), a Mobile Switching Center (MSC), a Base Station Controller (BSC), a Centralized Base Station Controller (CBSC), a Radio Network Controller (RNC), a Gateway Switching Node (GSN), a Node B, and a mobile unit.

14. A checkpointing method of stabilizing a system during an upgrade of services, the system having a primary controller comprising a first version of a control application, a secondary controller comprising a second version of a control application, and a checkpointing service, the method comprising the steps of:
operating the first version of a control application to control the system;
saving state data in a first format, wherein the state data is representative of a stable operation of the system, and wherein the first format of the state data is compatible with the first version of a control application;
utilizing the checkpointing service to save the state data to the secondary processor;
upgrading the second version of a control application;
quiescing the primary controller;
operating the upgraded second version of a control application to control the system;
converting the saved state data from the first format to a second format, wherein the second state data format is compatible with the upgraded second version of a control application; and
operating the second version of a control application to control the system, wherein the second version utilizes the converted state data to ensure stability.

15. A checkpointing method of stabilizing a system during a downgrade of services, the system having a primary controller comprising a first version of a control application, a secondary controller comprising a second version of a control application, and a checkpointing service, the method comprising the steps of:
operating the first version of a control application to control the system;
saving state data in a first format, wherein the state data is representative of a stable operation of the system, and wherein the first format of the state data is compatible with the first version of a control application;
utilizing the checkpointing service to save the state data to the secondary processor;
downgrading the second version of a control application;
converting the saved state data from the first format to a second format, wherein the second state data format is compatible with the downgraded second version of a control application;
quiescing the primary controller;
operating the downgraded second version of a control application to control the system; and
operating the second version of a control application to control the system, wherein the second version utilizes the converted state data to ensure stability.
